(19) United States
(12) Patent Application Publication
(10) Pub. No.: US 2015/0013777 A1
(43) Pub. Date: Jan. 15, 2015

(54) MULTI-PART CONCENTRIC MANIFOLD AND METHOD OF MAKING THE MANIFOLD

(71) Applicant: SPX Corporation, Charlotte, NC (US)

(72) Inventor: Michael T. Landrum, Rockford, IL (US)

(21) Appl. No.: 13/937,509

(22) Filed: Jul. 9, 2013

(51) Int. Cl. F16L 41/00

(52) U.S. Cl. CPC F16L 41/00
USPC 137/15.01; 137/561 A

(57) ABSTRACT

A manifold is provided. The manifold includes a first body having an outer curved surface; a second body having an inner curved surface corresponding to the outer curved surface of the first body; and a groove formed in one or both of the outer and inner curved surfaces, wherein the first body is dimensioned to fit within the second body so that the outer curved surface contacts the inner curved surface and the groove forms a fluid passage located in between the first and second bodies, the fluid passage having an inlet and an outlet. A method for assembling a manifold may also be provided.

### FIELD OF THE INVENTION

The present invention relates generally to a manifold. More particularly, the present invention relates to a multipart, concentric, compact manifold.

### BACKGROUND OF THE INVENTION

Manifolds are traditionally used to assist in the routing of various fluids. Often a single housing or block will have various pathways formed or machined in it in order to provide conduits for the fluid. Commonly, the housings or blocks are angular or rectangular shape. In many instances, the pathways are machined along horizontal or vertical surfaces. Or, in other words, generally in a straight line along a straight surface. However, there may be instances where a rectangular shaped manifold housing is not best suited. Furthermore, other manifold housing shapes may allow for a more compact design than conventional shapes.

Accordingly, it is desirable to provide a manifold and or a method for making a manifold that may have a geometric shape other than rectangular.

### SUMMARY OF THE INVENTION

The foregoing needs are met, to a great extent, by the present invention, wherein in one aspect an apparatus is provided that in some embodiments a manifold may have a non-rectangular shape and may be more compact.

In accordance with one embodiment of the present invention, a manifold is provided. The manifold includes a first body having an outer curved surface; a second body having an inner curved surface corresponding to the outer curved surface of the first body; and a groove formed in one or both of the outer and inner curved surfaces, wherein the first body is dimensioned to fit within the second body so that the outer curved surface contacts the inner curved surface and the groove forms a fluid passage located in between the first and second bodies, the fluid passage having an inlet and an outlet.

In accordance with another embodiment of the present invention, a method of assembling a manifold is provided. The method may include: forming a first body having an outer curved surface; forming a second body having an inner curved surface corresponding to the outer curved surface of the first body; and forming a groove in one or both of the outer and inner curved surfaces, wherein the first body is dimensioned to fit within the second body so that the outer curved surface contacts the inner curved surface and the groove forms a fluid passage located in between the first and second bodies, the fluid passage having an inlet and an outlet.

In accordance with yet another embodiment of the present invention, a manifold is provided. The manifold may include: a first body having an outer curved surface; a second body having an inner curved surface corresponding to the outer curved surface of the first body; and means for defining a pathway formed in one or both of the outer and inner curved surfaces, wherein the first body is dimensioned to fit within the second body and the means for forming a pathway is located in between the first and second bodies, the pathway having an inlet and an outlet.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an exploded perspective view of a manifold in accordance with an embodiment.

FIG. 2 is a perspective view of a manifold in accordance with an embodiment.

FIG. 3 is a perspective view of a manifold in accordance with another embodiment.

FIG. 4 is an exploded perspective view of a manifold in accordance with an embodiment.

### DETAILED DESCRIPTION

According to some embodiments, a generally circular shaped manifold 10 is provided. The manifold 10 may include an inner body 12. The inner body 12 may have an outer surface 14 of the inner body 12. Optionally, the inner body 12 may have a void or hole 16 in its center portion. In other embodiments, the inner body 12 may be solid at the center portion.

Grooves or pathways 18, 20, 22, and 24 may be formed on the outer surface 14 of the inner body 12. The grooves 18, 20, 22, and 24 are pathways which allow a fluid to flow within the manifold 10. For example, in some embodiments, various axial pathways 26 may be fluidly connected to each other via the grooves or pathways 18, 20, 22, and 24.

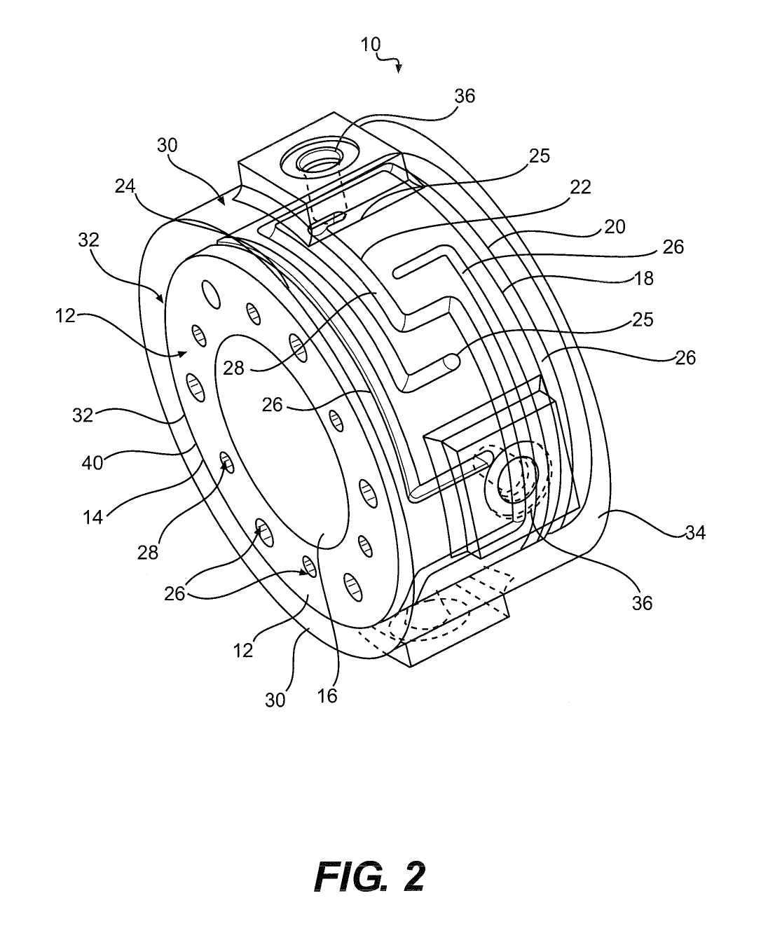

When the inner body 12 is tightly fit within the outer body 30, as shown in FIG. 2, the grooves or pathways 18, 20, 22, and 24 are fluidly isolated from each other. The fluid flows through the pathways 18, 20, 22, and 24 to provide fluid communication within the manifold 10 to various axial pathways 26. In some embodiments, the fluid may be hydraulic fluid. The hydraulic fluid may be at relatively high pressure so the fitting of the inner body 12 to the outer body 30 must the tightly fit or sealed to maintain fluid isolation between pathways 18, 20, 22 and 24. One of ordinary skill in the art after reviewing this disclosure will understand that the pressure of any fluids formed through the pathways 18, 20, 22, and 24, will need to be at a pressure less than a pressure required to separate the inner body 12 from the outer body 30 in order to maintain fluid isolation between the various pathways.

In some embodiments, the inner body 12 is press fit within the outer body 30. In other words, an initial dimension of the inner surface 32 of the outer body 30 may be smaller than the initial outer surface 14 of the inner body 12. In other embodiments of the invention, an adhesive may be used to fasten or seal the inner body 12 with in the outer body 30. In other embodiments, fasteners may be used.

In some embodiments, the outer body 30 may be heated so that the inner surface 32 expands. The inner body 12 may be then inserted into the outer body 30. When the outer body 30 cools it shrinks and tightly engages the inner body 14. In other embodiments, other methods of connecting the inner 14 and outer body 30 may be used.

On the outer surface 34 of the outer member 30, hydraulic ports 36 are located about various positions. The positions of the hydraulic ports 36 coincide so that they align with one of the grooves or pathways 18, 20, 22, and 24 allowing fluid communication between the hydraulic ports 36 and one of the grooves or pathways 18, 20, 22, and 24. In some embodiments, the hydraulic ports 36 may be located on blocks 38 located on the outer surface 34 of the outer member 30 as illustrated in the FIGs. As configured in the FIGs, hydraulic fluid may flow either in or out of the hydraulic ports 36 through the grooves or pathways 18, 20, 22, and 24 and through the axial pathways 26. In some embodiments of the invention, the hydraulic ports 36 may be in fluid communication with one or more of the axial pathways 26.

The grooves 18, 20, 22, and 24 may also have turns 25. The turns 25 provide a radial opening to fluidly connect the grooves 18, 20, 22, and 24 to one or more axial pathways 26.

A hydraulic port 36 may be part of the specific pathway 27. As a result, hydraulic fluid may flow to or from a hydraulic port 36 to a specific axial pathway 27.

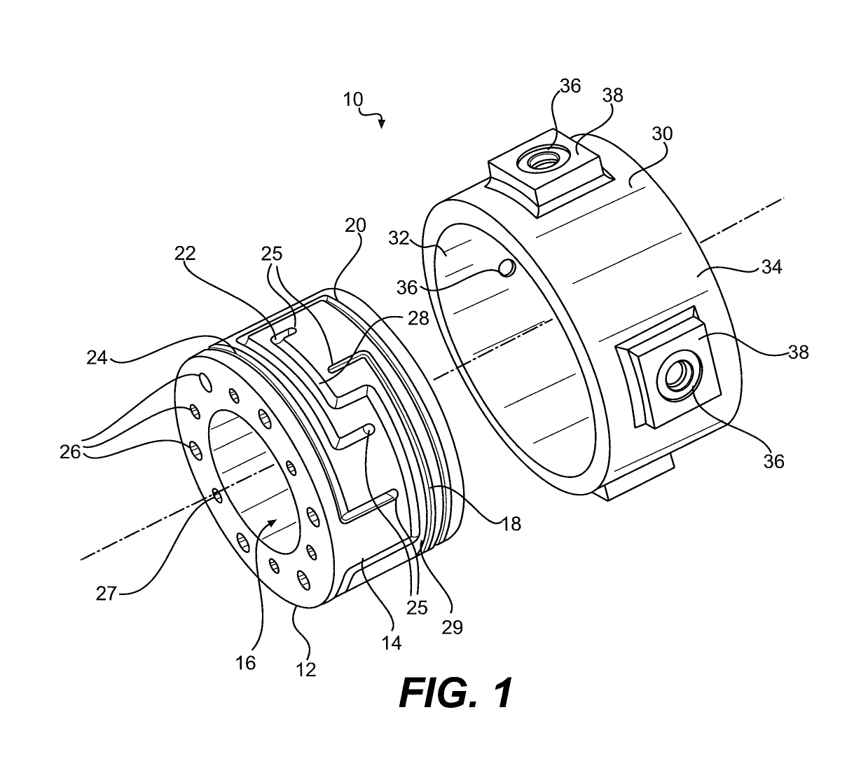

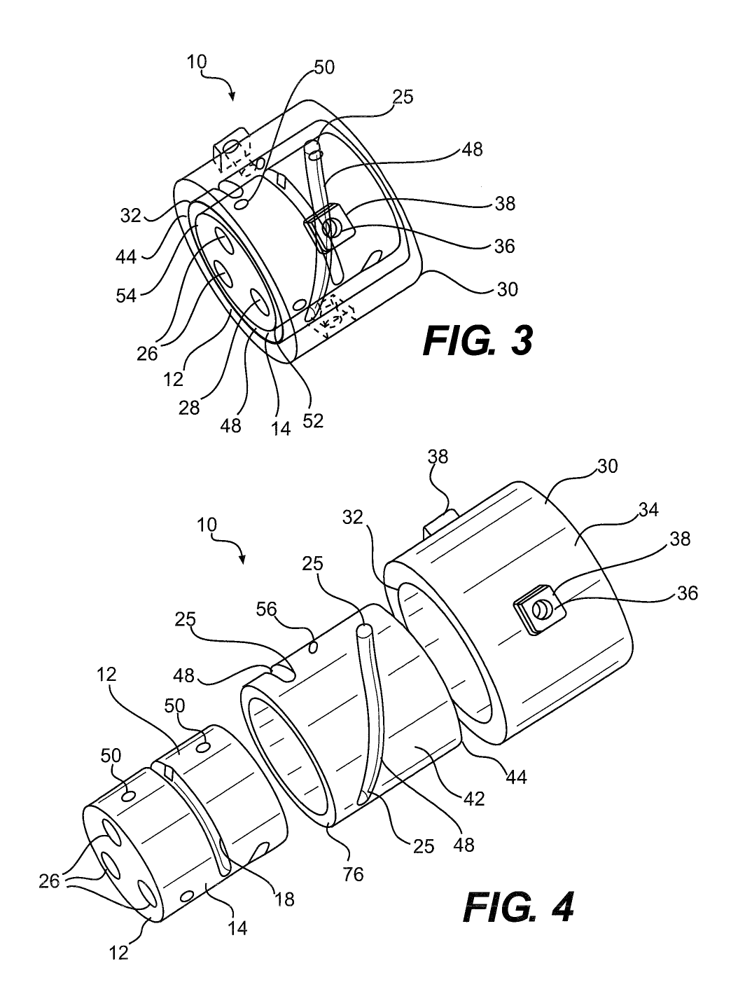

The turns 25 may terminate at the groove, 18, 20, 22, and 24 and be a through hole that fluidly connects the groove 22 to the axial pathways 26. However, the turns 25 are not limited to ends or terminations of the grooves 18, 20, 22 and 24 but may also occur at an intermediate point along the fluid pathway as illustrated by referenced numeral 27 in FIG. 1 along the pathway 22. Furthermore, the hydraulic ports 36 may be located over the turns 25 and the pathways 18, 20, 22, and 24 as illustrated in FIG. 2 or they may be located at intermediate positions on pathways as illustrated in FIGS. 3 and 4.

As an example, a specific hydraulic pathway indicated as referenced in numeral 28 may include specific axial pathway 27 and the groove indicated by reference numeral 22. The groove 22 is terminated with a turn 25 which provides fluid communication between the groove 22 and the axial pathways 26.

FIG. 4 is an exploded view and FIG. 3 is an assembled view of the manifold 10. In the embodiments shown in FIGS. 3 and 4, the manifold 10 includes and inner body 12 an intermediate body 42 and an outer body 30. The inner body 12 includes axial pathways 26, the axial pathways 26 are in fluid communication with the grooves 48, radial pathways 50 and the hydraulic ports 36.

The axial pathways 26 are connected via the radial pathway 50 to the turns 25. The turns 25 are fluidly connected to the groove 48 on the intermediate body 42 which is, in turn, fluidly connected to the hydraulic ports 36 in the blocks 38 on the outer body 30. Alternatively, the axial pathways 26 may be fluidly connected via the radial pathways 50 the groove 18 on the innerbody 12. The groove 18 on the innerbody 12 may be fluidly connected to one of the hydraulic ports 36 on the outerbody, 30 via a second radial pathway 56 located on the intermediate body 42.

One of ordinary skill in the art after reviewing this disclosure will understand how to connect or isolate varies axial pathways 26 from various grooves 48, turns 25, a radial pathways 50 and hydraulic ports 36.

As a result, anyone of the axial pathways 26 may be connected to one of the hydraulic ports 36 through either a groove 18, 20, 22, or 24 on the innerbody 12 or a groove 48 on the intermediate body 42 via the turns 25 or radial pathways 50. Thus, the fluid connections may be routed along the manifold 10 without being fluidly connected with each other. As shown in FIGS. 3 and 4, the pathways defined by the grooves 18 or 48 may even cross over each other (one pathway being on the inner body 12 and the other on the intermediate body 42) but are not fluidly connected.

While only a certain number of axial pathways 26, grooves 18, 20, 22 and 24, turns 25 being, radial pathways 50 and hydraulic ports 36 are shown, one of ordinary skill in the art will understand that more of fewer may be used to achieve a desired result.

Similar to that described above, the innerbody 12 may fit within the intermediate body 42. The intermediate body 42 may fit within the outer body 30. It may be desirable in some embodiments for the connections 52 between the innerbody 12 and the intermediate body 42 to be fluid tight so that fluid does not leak out from the groove 18 or the radial pathways 50. This may be accomplished in several ways. For example, the innerbody 12 may be press fit with the intermediate body 42. In other embodiments, the intermediate body 42 is heated as to expand. Once the intermediate body 42 has expanded, the innerbody 12 can be inserted into the intermediate body 42. As the intermediate body 42 cools, it will shrink, thereby tightening and making fluid tight the connection 52 between the innerbody 12 and the intermediate body 42.

Similarly, it may be desirable for the connection between the intermediate body 42 and the outer body 30 to also be fluid tight. Similar to that described above, the intermediate body 42 may be press fit with the outerbody 30. In some embodiments, the outerbody 30 heated thereby expanding allowing the intermediate body 42 to be inserted into the outerbody 30. As the outerbody 30 cools, it will shrink and thereby form a fluid tight connection to the intermediate body 42.

In other embodiments the connection 52 between the intermediate body 42 and the innerbody 12 and/or the connection 54 between the intermediate body 42 and the outerbody 30 may also be accomplished using adhesives, sealants, and or fasteners in order to help the connections 52, 54 to be fluid tight. In other embodiments, other ways of fastening the bodies 14, 30 and 42 may be used.

It is anticipated that some embodiments that the fluid that will be flowing through the manifold will be hydraulic fluid under pressure. However, in other embodiments, other fluids may be used. Fluids may be in liquid or gas form. Hydraulic fluid is mentioned here only as an example and is in no way limiting the invention to hydraulic manifolds.

The grooves 18, 20, 22, 24 and 48 are shown and described to be on the outer surfaces 14 and 44 of the inner or intermediate bodies 12 and 42. After reviewing this disclosure, one of ordinary skill in the art will appreciate that the grooves 18, 20, 22, 24 and 48 could also be located on the inner surfaces 32 and 46 of the intermediate 42 or outer 30 bodies or both. The outer surfaces 14 and 42 of the inner and intermediate bodies 12 and 24 and the inner surfaces 32 and 46 of the intermediate 42 and outer bodies 30.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A manifold comprising:
a first body having an outer surface;
a second body having an inner surface corresponding to the outer surface of the first body; and
a groove formed in one or both of the outer and inner surfaces, wherein the first body is dimensioned to fit within the second body so that the outer surface contacts the inner surface and the groove forms a fluid passage located in between the first and second bodies, the fluid passage having an inlet and an outlet.

2. The manifold of claim 1, wherein the outer surface and the inner surfaces are substantially circular.

3. The manifold of claim 1, wherein the first body is friction fit within the second body.

4. The manifold of claim 1, wherein the first and second bodies are bonded together with a bonding agent.

5. The manifold of claim 1, further comprising an additional groove and the additional groove is fluidly isolated from the groove.

6. The manifold of claim 1, wherein the groove is located on the outer surface of the first member.

7. The manifold of claim 1, wherein an inlet/outlet for the groove is located on the second body.

8. The manifold of claim 1, wherein an inlet/outlet for the groove is located in the first body.

9. The manifold of claim 1, further comprising:
a third body having an inner surface and the second body has an outer surface corresponding to the inner surface on the second body; and
a second groove formed in one or both of the outer surface of the second body and the inner surface of the third body, wherein the second body is dimensioned to fit within the third body so that the outer surface on the second body contacts the inner surface on the third body and the second groove forms a fluid passage located in between the second and third bodies.

10. The manifold of claim 9, wherein the outer surface and the inner surfaces are substantially circular.

11. The manifold of claim 9 wherein and the second body is friction fit within the third body.

12. The manifold of claim 9, wherein the second and third bodies are bonded together with a bonding agent.

13. The manifold of claim 9, wherein an inlet/outlet for the groove is located on the third body.

14. A method of assembling a manifold comprising:
forming a first body having an outer surface;
forming a second body having an inner surface corresponding to the outer surface of the first body; and
forming a groove in one or both of the outer and inner surfaces, wherein the first body is dimensioned to fit within the second body so that the outer curved surface contacts the inner surface and the groove forms a fluid passage located in between the first and second bodies, the fluid passage having an inlet and an outlet.

15. The method of claim 14, further comprising heating the second body thereby expanding it and inserting the first body into the second body.

16. The method of claim 14, further comprising:
forming a third body having an inner surface and the second body has an outer surface corresponding to the inner surface on the second body; and
forming a second groove formed in one or both of the outer surface of the second body and the inner surface of the third body, wherein the second body is dimensioned to fit within the third body so that the outer surface on the second body contacts the inner surface on the third body and the second groove forms a fluid passage located in between the second and third bodies.

17. The method of claim 16, further including heating the third body thereby expanding it and inserting the second body into the third body.

18. The method of claim 16, wherein the second groove crosses over the first groove and the first and second groove do not intersect due to the second groove being located radially outward from the first groove.

19. The method of claim 14, further including bonding the first body to the second body.

20. A manifold comprising:
a first body having an outer surface;
a second body having an inner surface corresponding to the outer surface of the first body; and
means for defining a pathway formed in one or both of the outer and inner surfaces, wherein the first body is dimensioned to fit within the second body and the means for forming a pathway is located in between the first and second bodies, the pathway having an inlet and an outlet.
